(19) United States
(12) Patent Application Publication
(10) Pub. No.: US 2009/0036100 A1
(43) Pub. Date: Feb. 5, 2009

(54) Mobile communication terminal having touch screen and method for locking and inlocking the terminal

(75) Inventor: Kwang Won Lee, Suwon-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 12/220,875

(22) Filed: Jul. 29, 2008

(30) Foreign Application Priority Data
Aug. 1, 2007 (KR) 2007-0077534

(51) Int. Cl. H04M 1/675

(52) U.S. Cl. 455/411

(57) ABSTRACT

A mobile communication terminal having a touch screen and a method for locking and unlocking the touch screen are disclosed. The touch function can be interrupted or activated when key patterns are input to the touch screen. The locking/unlocking method includes registering a key pattern for allowing the touch screen to enter a locking mode or an unlocking mode, and entering one of the locking and unlocking modes when a pattern input through the touch screen is the registered key pattern.

### CROSS-REFERENCE TO RELATED APPLICATION(S) AND CLAIM OF PRIORITY

The present This application claims priority to an application entitled “MOBILE COMMUNICATION TERMINAL HAVING TOUCH SCREEN AND METHOD FOR LOCKING AND UNLOCKING THE TERMINAL” filed in the Korean Intellectual Property Office on Aug. 1, 2007 and assigned Serial No. 2007-0077534, the contents of which are incorporated herein by reference.

### TECHNICAL FIELD OF THE INVENTION

The present invention relates to mobile communication systems, and more particularly, to a mobile communication terminal having a touch screen that can interrupt or activate touch functions of the touch screen as key patterns are input. This invention also relates to a method for locking and unlocking the mobile communication terminal.

### BACKGROUND OF THE INVENTION

The market for mobile communication terminals has grown rapidly over a short period of time as technology related to mobile communication terminals has developed so that new functions stimulate consumers' purchasing appetite. In recent years, mobile communication terminals have installed a variety of application programs to comply with users' requirement thereto, and provide users with various services. For example, mobile communication terminals allow users to use voice information, letter information, image information, MP3 player function, game service, etc. In particular, mobile communication terminals having a touch screen that can perform a display function and an input function have been developed and these have gradually been adopted by users.

The conventional mobile communication terminals input information as users touch the touch screen installed thereto and perform a corresponding function, so that they can provide users with a convenient method of usage. However, the conventional mobile communication terminals having a touch screen are disadvantageous in that the touch screen may be activated unintentionally by the touch of a user, so that they perform an unintended function. Therefore, a system is needed which is not activated by unintentional touching.

### SUMMARY OF THE INVENTION

To address the above-discussed deficiencies of the prior art, it is a primary object to provide a system that can interrupt or activate the touch functions of a touch screen as the touch screen is adjusted.

The present invention further provides a system that allows users to easily operate a touch screen.

In accordance with the present invention, the present invention provides a mobile communication terminal having a touch screen that can interrupt or activate touch functions of the touch screen as key patterns are input, and provides a method for locking and unlocking the mobile communication terminal.

In accordance with an exemplary embodiment of the present invention, the present invention provides a locking/unlocking method of a mobile communication terminal having a touch screen, including: registering a key pattern that allows the touch screen to enter a locking mode or an unlocking mode; and entering one of the locking and unlocking modes when a pattern input through the touch screen is the registered key pattern.

In accordance with another exemplary embodiment of the present invention, the present invention provides a mobile communication terminal including: a touch screen; a key pattern registering unit for registering a key pattern that allows the touch screen to enter a locking mode or an unlocking mode; a key pattern determining unit for determining whether a pattern, input through the touch screen, is the registered key pattern; and a locking/unlocking operation unit for allowing the touch screen to enter a locking mode or an unlocking mode, when the input pattern is the registered key pattern.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior uses, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic block diagram illustrating a mobile communication terminal having a touch screen according to an embodiment of the present invention;

FIG. 2 is a flow chart describing a method for locking and unlocking a mobile communication terminal having a touch screen according to an embodiment of the present invention;

FIG. 3 is a flow chart describing a process of registering a key pattern in FIG. 2;

FIG. 4 is a flow chart describing processes of determination and locking/unlocking operations according to an embodiment of the present invention; and

FIG. 5 is a flow chart describing processes of determination and locking/unlocking operations according to another embodiment of the present invention.

### DETAILED DESCRIPTION OF THE INVENTION

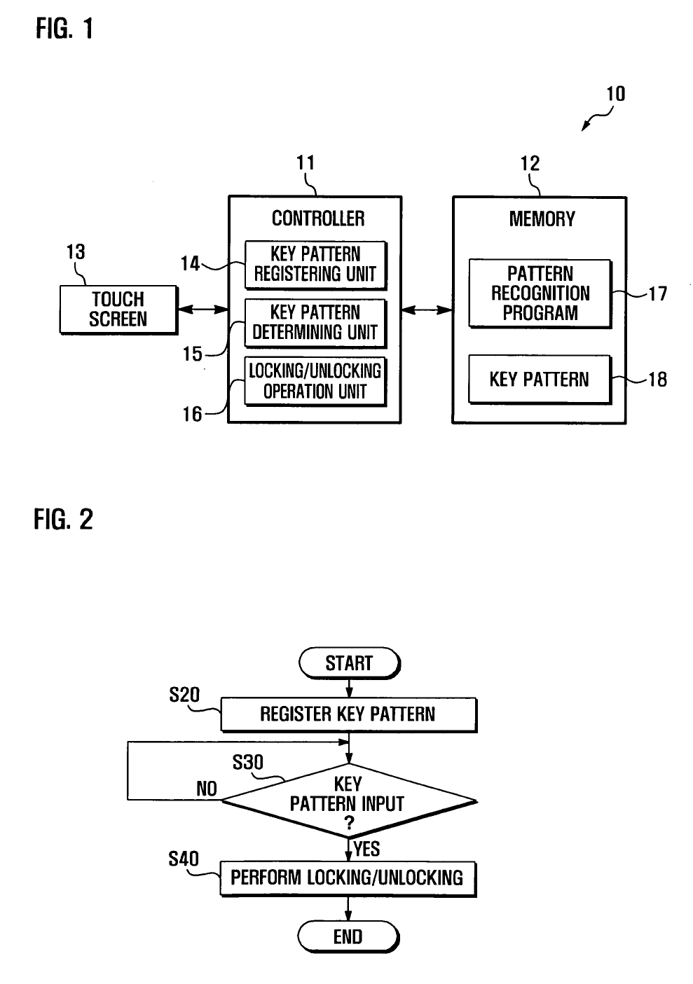

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile communication system.

The mobile communication terminal, according to the present invention, refers to a terminal having a touch screen and may be a wireless terminal, a personal digital assistant (PDA) terminal, a portable multimedia player (PMP), a digital camera, etc.

Mobile Communication Terminal

As shown in FIG. 1, the mobile communication terminal 10, according to an embodiment of the present invention, includes a controller 11, a memory 12 and a touch screen 13.

The controller 11 is implemented by a microprocessor that controls the whole operation of the mobile communication terminal 10. The controller 11 controls the locking and unlocking operations for a touch function according to whether a key pattern is input.

The memory 12 stores programs for controlling the mobile communication terminal 10 and data generated when the programs are executed. The memory 12 includes at least one or more volatile memory device and non-volatile memory device. In particular, the memory 12 stores a pattern recognition program 17 that recognizes input patterns and performs locking/unlocking operations, and a key pattern 18 registered while the pattern recognition program 17 is executed. The key pattern 18 may be stored in the memory, as a default, or provided thereto as per a user's input. The key pattern 18 includes a locking key pattern or an unlocking key pattern. The locking key pattern serves to interrupt a touch function in the touch screen 13 and is input to perform a locking mode. The unlocking key pattern unlocks the locking mode. The unlocking key pattern serves to activate a touch function in the touch screen 13 and is input to perform an unlocking mode. The key pattern 18 may be one of letters, symbols, or user-defined patterns. The user-defined pattern is a particularly shaped pattern defined by a user's input. The key pattern 18 has a shape that can be formed as at least one drag operation is performed in the touch screen 13.

The touch screen 13 displays information about operation states of the mobile communication terminal 10 and data stored in the memory 12. In particular, the touch screen 13 interrupts or activates operations of a touch function according to whether a key pattern 18 is input.

The controller 11 may include a key pattern registering unit 14, a key pattern determining unit 15, and a locking/unlocking operation unit 16, so as to control operations of locking/unlocking modes through the touch screen 13.

The key pattern registering unit 14 registers patterns input or selected in a key pattern registering mode and stores them in the memory 12. The locking key pattern and unlocking key pattern may be implemented in such a way to be different from each other or similar to each other. The key pattern registering unit 14 can register at least one of the patterns, as a key pattern 18, which are displayed as a default on the touch screen 13, in a key pattern registering mode. The key pattern registering unit 14 can also register patterns as a key pattern 18, which are directly input by a user. On the other hand, the key pattern registering unit 14 registers at least one key pattern 18 as an unlocking key pattern and a locking key pattern according to a user's selection or input.

The key pattern determining unit 15 determines whether a pattern input through the touch screen 13 is a registered key pattern 18. The key pattern determining unit 15 can input the pattern through a certain area of the touch screen 13. In order to determine whether a pattern input through the touch screen 13 is a registered key pattern 18, the key pattern determining unit 15 checks the likeness between the input pattern and the registered key pattern 18, regardless of the size of the two patterns.

When the input pattern is a registered key pattern 18, the locking/unlocking operation unit 16 performs a locking mode or an unlocking mode according to the registered key pattern 18.

When the locking key pattern and the unlocking key pattern are different from each other, the locking/unlocking operation unit 16 performs a locking mode or an unlocking mode according to whether a locking key pattern or an unlocking key pattern is input.

On the contrary, when the locking key pattern and the unlocking key pattern are identical to each other, that is, when the single key pattern 18 is used for the locking and unlocking key patterns, the locking/unlocking operation unit 16 switches a currently set mode to the other mode according to the input of the registered key pattern 18. For example, when a key pattern 18 is input during the operation of the locking mode, the locking/unlocking operation unit 16 switches the current locking mode to an unlocking mode. On the contrary, when a key pattern 18 is input during the operation of the unlocking mode, the locking/unlocking operation mode 16 switches the current unlocking mode to a locking mode.

In particular, the key pattern determining unit 15 determines whether an unlocking key pattern is input through the touch screen 13, in a locking mode according to the input of the locking key pattern. However, when patterns other than the unlocking key pattern are input during the operation of the locking mode, the locking/unlocking operation unit 16 ignores the input patterns and maintains the locking mode. While the locking mode is performed, the touch screen 13 does not display any image data. While the locking mode is performed, the touch screen 13 may display current image data.

The mobile communication terminal 10, according to an embodiment of the present invention, may further include a key input unit and an RF communication unit for performing wireless communication. The key input unit includes function keys for particular functions, such as an ON/OFF power key, a volume up/down key, etc., which are not included in the drawings. The mobile communication terminal 10 may also include at least one of the following: camera module, Bluetooth module, digital broadcasting receiver, and global positioning system (GPS) receiver.

Locking/Unlocking Method

The following description describes a locking/unlocking method of a mobile communication terminal 10 having a touch screen 13, according to an embodiment of the present invention, with reference to FIG. 1 and FIG. 2. The locking/unlocking method includes registering a key pattern 18 (S20), determining whether the key pattern 18 is input (S30), and performing a locking mode or an unlocking mode (S40) when the input key pattern 18 is input at S30.

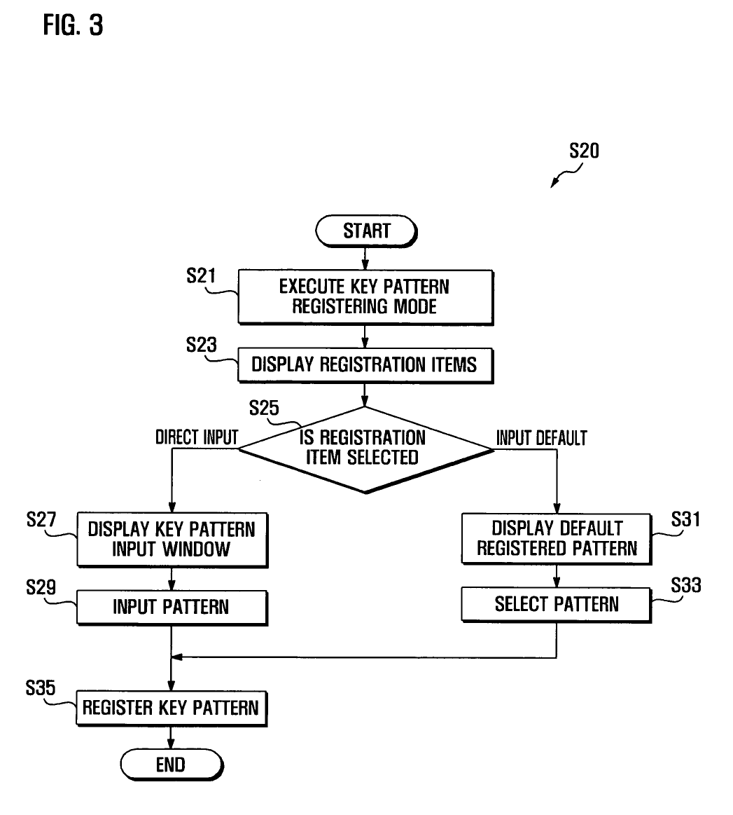

The step, S20, of registering a key pattern 28 is described in detail as follows with reference to FIG. 1 and FIG. 3.

First, a key pattern registering mode is entered (S21). The key pattern registering mode is activated by selecting an item for a key pattern registering mode, which is one of the execution modes displayed on the touch screen 13. The key pattern registering mode can be selected by touching the key pattern registering mode item from the execution modes displayed on the touch screen 13.

When the key pattern registering mode is entered at S21, the key pattern registering unit 14 displays registering items on the touch screen 13 (S23). The registering items may include a direct input item and a default input item. A user can touch and select the direct input item or the default input item.

After that, the key pattern registering unit 14 determines which one of the registering items displayed on the touch screen 13 is selected (S25).

When a direct input item is selected at S25, the key pattern registering unit 14 displays a key pattern input window for inputting patterns used for a key pattern 18 on the touch screen 13 (S27). The user inputs patterns for a key pattern 18 by touching (S29). The key pattern registering unit 14 may display the key pattern input window and a key pattern exemplary window together. The key pattern exemplary window shows exemplary patterns used for a key pattern 18 and guides a user to input the key pattern 18. The user can watch the exemplary key patterns through the key pattern exemplary window and easily input a pattern used for a key pattern.

Next, when the user asks for a registration through the touch screen 13, the key pattern registering unit 14 registers the input pattern as a key pattern 18 and then stores it in the memory 12 (S35). The input pattern may be registered as a locking key pattern or an unlocking key pattern. The input pattern may also be registered as a locking and unlocking key pattern.

On the other hand, when a default input item is selected at S25, the key pattern registering unit 14 displays the default registered pattern on the touch screen 13 (S31). The user touches and selects a pattern for a key pattern 18, which is one of the patterns displayed on the touch screen (S33). The key pattern registering unit 14 registers the selected pattern as a key pattern 18 and then stores it in the memory 12 (S35). The input pattern may be registered as a locking key pattern or an unlocking key pattern. The input pattern may also be registered as a locking and unlocking key pattern.

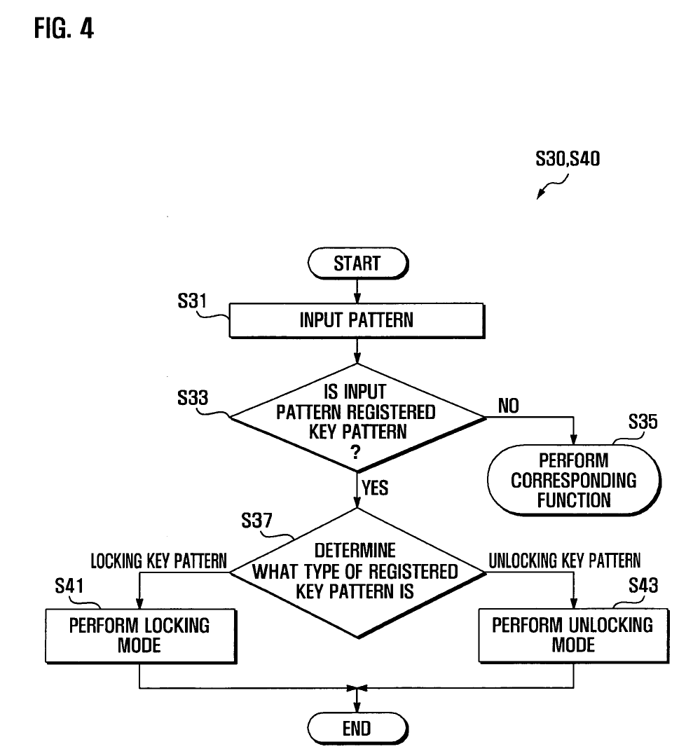

The determination of S30 and the step, S40, of performing a locking mode or an unlocking mode, according to an embodiment of the present invention, are described in detail as follows with reference to FIG. 1 and FIG. 4. FIG. 4 shows a flow chart describing the determination (S30) and the locking/unlocking operations (S40) in the case that a locking key pattern and an unlocking key pattern are individually registered.

First, when a pattern is input through a certain area of the touch screen 13 (S31), the key pattern determining unit 15 determines whether the input pattern is a registered key pattern 18 (S33). In order to determine whether the input pattern is a registered key pattern 18, the key pattern determining unit 15 checks the likeness between the input pattern and the registered key pattern 18, regardless of the size of the patterns.

When the input pattern is not the registered key pattern 18 at S33, the controller 11 performs a corresponding function (S35). The corresponding function when the mobile communication terminal 10 enters a locking mode means a case where patterns other than an unlocking key pattern are input through the touch screen 13, i.e., a current locking mode is maintained. In addition, the corresponding function when the mobile communication terminal 10 enters an unlocking mode means a case where patterns other than a locking key pattern are input through the touch screen 13, i.e., functions according to input patterns are performed.

When the input pattern is the registered key pattern 18 at S33, the key pattern determining unit 15 determines the type of registered key pattern 18 corresponding to the input pattern (S37).

When the input pattern is a locking key pattern at S37, the locking/unlocking operation unit 16 allows the touch screen 13 to enter a locking mode (S41).

On the other hand, when the input pattern is an unlocking key pattern at S37, the locking/unlocking operation unit 16 allows the touch screen 13 to release the locking mode and to enter an unlocking mode where a function according to a touch is activated (S43).

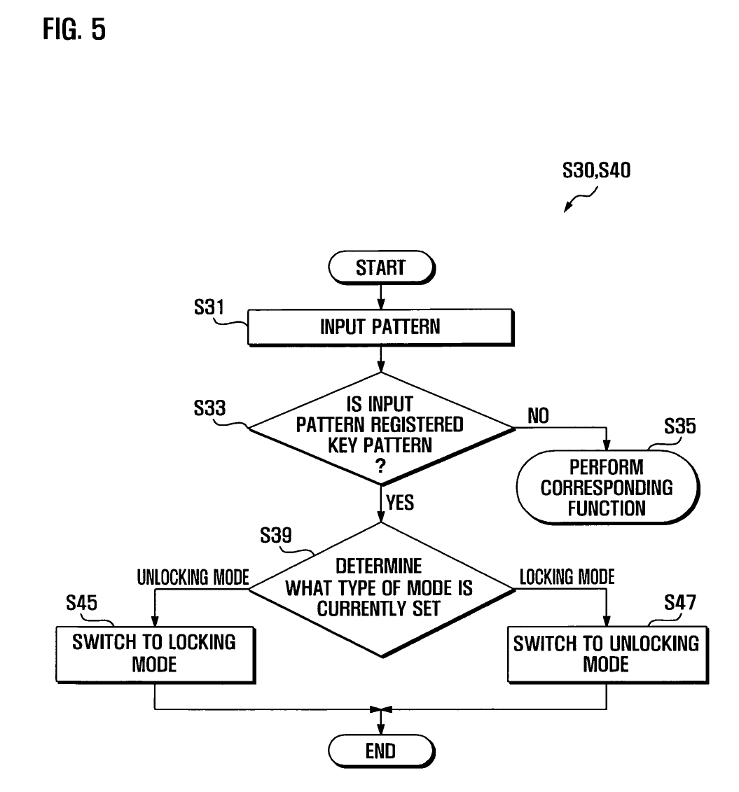

The determination of S30 and the step, S40, of performing a locking mode or an unlocking mode, according to another embodiment of the present invention, are described in detail as follows with reference to FIG. 1 and FIG. 5. FIG. 4 shows a flow chart describing the determination (S30) and the locking/unlocking operations (S40) in the case that a single key pattern 18 is used for a locking and unlocking key pattern.

Since steps S31 to S35 are the same as those in FIG. 4 and have been already explained above, their detailed description is omitted in the following description.

When the input pattern is a registered key pattern 18 at S33, the locking/unlocking operation unit 16 determines a mode currently set in the touch screen 13 (S39). Here, the currently set mode of the touch screen 13 is a locking mode or a setting mode.

When the currently set mode is an unlocking mode at S39, the locking/unlocking operation unit 16 switches the unlocking mode to a locking mode (S45). On the contrary, when the currently set mode is a locking mode at S39, the locking/unlocking operation unit 16 switches the locking mode to an unlocking mode (S47).

When a single key pattern 18 is used for a locking and unlocking key pattern, a user can memorize only one type of key pattern 18 and thus easily switches between the locking and unlocking modes.

As described above, the mobile communication terminal having a touch screen, according to the present invention, can interrupt (or perform a locking mode) or activate (or perform an unlocking mode) touch operations as a key pattern is input, thereby providing a user with enhanced convenience. In addition, since the locking and unlocking mode can prevent unnecessary touching of the touch screen, power consumption due to an unnecessary function operation can be reduced.

The mobile communication terminal user can easily set the locking and unlocking mode by inputting a simple key pattern.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A locking/unlocking method of a mobile communication terminal having a touch screen, comprising:
registering a key pattern that allows the touch screen to enter a locking mode or an unlocking mode; and
entering one of the locking and unlocking modes when a pattern input through the touch screen is the registered key pattern.

2. The method of claim 1, wherein the key pattern comprises:
a locking key pattern for allowing the touch screen to enter the locking mode where a touch function is interrupted in the touch screen; and
an unlocking key pattern for allowing the touch screen to enter the unlocking mode where a touch function is activated in the touch screen.

3. The method of claim 2, wherein entering one of the locking and unlocking modes comprises:
determining the type of registered key pattern corresponding to the input pattern, when the input pattern is the registered key pattern; and
entering a locking mode when the input pattern is a locking key pattern, and entering an unlocking mode when the input pattern is an unlocking key pattern.

4. The method of claim 1, wherein entering one of the locking and unlocking modes comprises:
determining which type of mode is currently set in the touch screen when the input pattern is the registered key pattern; and
switching the currently set mode to an unlocking mode when the currently set mode is a locking mode, and switching the currently set mode to a locking mode when the currently set mode is an unlocking mode.

5. The method of claim 1, wherein registering a key pattern refers to registering at least one pattern, which is registered as a default, as a key pattern.

6. The method of claim 1, wherein registering a key pattern is to register the pattern, which is input through the touch screen, as a key pattern.

7. The method of claim 1, wherein the input pattern is input through a certain area of the touch screen.

8. The method of claim 1, further comprising:
determining whether the input pattern is the registered key pattern,
wherein the determination checks the likeness between the input pattern and the registered key pattern, regardless of the size of the patterns.

9. The method of claim 1, wherein registering a key pattern comprises:
displaying a registering item that includes a direct input item and a default input item when a key pattern registering mode is selected through the touch screen;
displaying patterns registered as a default when the default input item of the displayed registering items is selected; and
registering at least one of the displayed patterns as a key pattern.

10. The method of claim 9, wherein registering a key pattern comprises:
displaying a key pattern input window when the direct input item is selected; and
registering a pattern, input by touching the key pattern input window, as a key pattern.

11. A mobile communication terminal comprising:
a touch screen;
a key pattern registering unit for registering a key pattern that allows the touch screen to enter a locking mode or an unlocking mode;
a key pattern determining unit for determining whether a pattern, input through the touch screen, is the registered key pattern; and
a locking/unlocking operation unit for allowing the touch screen to enter a locking mode or an unlocking mode when the input pattern is the registered key pattern.

12. The mobile communication terminal of claim 11, wherein the key pattern comprises:
a locking key pattern for allowing the touch screen to enter the locking mode where a touch function is interrupted in the touch screen; and
an unlocking key pattern for allowing the touch screen to enter the unlocking mode where a touch function is activated in the touch screen.

13. The mobile communication terminal of claim 12, wherein the locking/unlocking operation unit:
determines the type of registered key pattern corresponding to the input pattern when the input pattern is the registered key pattern;
enters a locking mode when the input pattern is a locking key pattern; and
enters an unlocking mode when the input pattern is an unlocking key pattern.

14. The mobile communication terminal of claim 11, wherein the locking/unlocking operation unit:
determines which type of mode is currently set in the touch screen when the input pattern is the registered key pattern;
switches the currently set mode to an unlocking mode when the currently set mode is a locking mode; and
switches the currently set mode to a locking mode when the currently set mod is an unlocking mode.

15. The mobile communication terminal of claim 11, wherein the key pattern registering unit registers at least one pattern, which is registered as a default, as a key pattern.

16. The mobile communication terminal of claim 11, wherein the key pattern registering unit registers the pattern, which is input thorough the touch screen, as a key pattern.

17. The mobile communication terminal of claim 11, wherein the key pattern determining unit inputs the key pattern through a certain area of the touch screen.

18. The mobile communication terminal of claim 11, wherein the key pattern determining unit determines whether the input pattern is the registered key pattern by checking the likeness between the input pattern and the registered key pattern, regardless of the size of the patterns.

19. The mobile communication terminal of claim 11, wherein the key pattern registering unit:
displays a registering item that includes a direct input item and a default input item when a key pattern registering mode is selected through the touch screen;
displays patterns registered as a default when the default input item of the displayed registering items is selected; and
registers at least one of the displayed patterns as a key pattern.

20. The mobile communication terminal of claim 19, wherein the key pattern registering unit:
displays a key pattern input window when the direct input item is selected; and
registers a pattern, input by touching the key pattern input window, as a key pattern.
